(19) United States
(12) Patent Application Publication
(10) Pub. No.: US 2002/0154350 A1
(43) Pub. Date: Oct. 24, 2002

(54) Optical logic devices based on stable, non-absorbing optical hard limiters

(76) Inventors: Erik V. Johnson, Toronto (CA); Edward H. Sargent, Toronto (CA)

Correspondence Address: BROMBERG & SUNSTEIN LLP, NORTEL NETWORKS LIMITED, 600 TECHNOLOGY PARK DRIVE, MS E65-60-403, BILLERICA, MA, 01821, US

(21) Appl. No.: 09/933,315

(22) Filed: Aug. 20, 2001

Related U.S. Application Data
(60) Provisional application No. 60/267,879, filed on Feb. 9, 2001.

(51) Int. Cl. G06E 1/00; G02F 3/00

(52) U.S. Cl. 359/108; 359/107

(57) ABSTRACT

Various optical logic devices are formed using stable, non-absorbing optical hard limiters. These optical logic devices are able to process information optically without the need to convert the information to an electronic form for processing electronically.

### PRIORITY

The present application claims priority from U.S. Provisional Patent Application No. 60/267,879, which was filed on Feb. 9, 2001, and is hereby incorporated herein by reference in its entirety.

### CROSS-REFERENCE TO RELATED APPLICATION(S)

The present application may be related to the following commonly owned United States patent application, which is hereby incorporated herein by reference in its entirety:

U.S. patent application Ser. No. XX/XXX,XXX entitled OPTICAL LIMITER BASED ON NONLINEAR REFRACTION, filed on May 1, 2001 in the names of Edward H. Sargent and Lukasz Brzozowski.

### FIELD OF THE INVENTION

The present invention relates generally to optical information processing, and more particularly to optical logic gates based on stable, non-absorbing optical hard limiters.

### BACKGROUND OF THE INVENTION

In today's information age, optical communication technologies are being used more and more frequently for transmitting information at very high speeds. Traditionally, information processing equipment (such as switches, routers, and computers) process information electronically. Therefore, optical communications are often converted into electronic form for processing by the information processing equipment. This electronic processing is slow relative to the speed of the optical communications themselves, and thus often becomes a “bottleneck” of optical communication and processing systems.

### SUMMARY OF THE INVENTION

In accordance with one aspect of the invention, various optical logic devices are formed using stable, non-absorbing optical hard limiters. These optical logic devices are able to process information optically without the need to convert the information to an electronic form for processing electronically.

In accordance with another aspect of the invention, an optical gain element is formed using three stable, non-absorbing optical hard limiters.

In accordance with yet another aspect of the invention, an optical AND gate is formed using the transmitted signal of a single stable, non-absorbing optical hard limiter.

In accordance with still another aspect of the invention, an optical OR gate is formed using an optical gain element.

In accordance with still another aspect of the invention, an optical XOR gate is formed by coupling the reflected output of a stable, non-absorbing optical hard limiter as the input to an optical gain element.

In accordance with still another aspect of the invention, an optical NOT gate is formed by coupling the reflected output of a stable, non-absorbing optical hard limiter as the input to an optical gain element.

In accordance with still another aspect of the invention, an optical NAND gate is formed by coupling the output of an optical AND gate as the input to an optical NOT gate.

In accordance with still another aspect of the invention, an optical NOR gate is formed by coupling the output of an optical OR gate as the input to an optical NOT gate.

### BRIEF DESCRIPTION OF THE DRAWINGS

In the accompanying drawings:

FIG. 1 is a schematic block diagram showing the input, transmitted output, and reflected output of an exemplary optical hard limiter in accordance with an embodiment of the present invention;

FIG. 2A is a graph showing the idealized transmitted transfer function of an optical hard limiter in accordance with an embodiment of the present invention;

FIG. 2B is a graph showing the simulated transmitted transfer functions for finite optical hard limiters with different numbers of layers in accordance with an embodiment of the present invention;

FIG. 3 is a graph showing the idealized reflected transfer function of an optical hard limiter in accordance with an embodiment of the present invention;

FIG. 4 is a schematic block diagram showing an optical gain element in accordance with an embodiment of the present invention;

FIG. 5 is a graph showing the idealized transfer function of an optical gain element in accordance with an embodiment of the present invention;

FIG. 6 is a schematic block diagram showing an optical AND gate in accordance with an embodiment of the present invention;

FIG. 7 is a schematic block diagram showing an optical OR gate in accordance with an embodiment of the present invention;

FIG. 8 is a schematic block diagram showing an optical XOR gate in accordance with an embodiment of the present invention;

FIG. 9 is a schematic block diagram showing an optical NOT gate in accordance with an embodiment of the present invention;

FIG. 10 is a schematic block diagram showing an optical NAND gate in accordance with an embodiment of the present invention; and

FIG. 11 is a schematic block diagram showing an optical NOR gate in accordance with an embodiment of the present invention.

### DETAILED DESCRIPTION OF A PREFERRED EMBODIMENT

All-optical logic devices are able to process information optically without the need to convert the information to an electronic form for processing electronically.

All-optical logic devices typically either continue to rely on electronic carrier transitions, such as those which rely on semiconductor optical amplifiers, (U.S. Pat No. 5,999,283) or diode/laser/LED/SEED/variable transmission combinations, (U.S. Pat. Nos. 4,128,300, 4,764,889), consist of non-integrable systems, (U.S. Pat. Nos. 4,932,739, 4,962,987, 4,992,654, 5,078,464, 5,144,375, 5,655,039, 5,831,731) narrowly defined devices which can only perform a single operation, (U.S. Pat. Nos. 5,315,422, 5,831,731), extremely slow devices (U.S. Pat. No. 6,005,791) or other interference effect devices (U.S. Pat. Nos. 4,262,992, 5,623,366). The devices that use carriers do not circumvent the fundamental limit, although they do allow this limit to be more closely approached. These devices are most useful when only the fast components of the nonlinearity are sampled, such as are done in time division demultiplexers. The non-integrable systems, although interesting laboratory experiments and good proofs-of-concept, are not practical for commercial application. The narrowly defined, but integrable, devices do not have the flexibility to enable large scale integration, and since they typically rely on a loss mechanism, such as coupling to a radiative mode, are not efficient for multiple levels of switching.

The all-optical logic devices of the present invention are based on stable non-absorbing optical hard limiters. An exemplary stable, non-absorbing optical hard limiter is described in the related application entitled OPTICAL LIMITER BASED ON NONLINEAR REFRACTION, which was incorporated by reference above. Typically, these stable non-absorbing optical hard limiters consist of alternating layers of materials with different linear indices and oppositely signed Kerr coefficients. This construction maintains the center of the stopband in generally the same spectral location, thereby providing stability. The linear and non-linear indices of the layers are such that the material with the lower linear index has a positive Kerr coefficient and the material with the higher linear index has a negative Kerr coefficient. Devices with these properties typically exhibit three regimes of operation, specifically a first regime bounded by input intensities from 0 to I1 in which the signal is completely reflected, a second regime bounded by input intensities from I1 to I2 in which the transmitted signal increases and the reflected signal decreases as intensity increases, and a third regime above input intensity I2 in which all light above a certain level is reflected. The existence of these three regimes enables these devices to be used in optical logic applications. As the nonideality of the device increases, the curve is smoothed. For these devices, I2 is defined as the input intensity at which the built-in optical grating has disappeared completely, and I1 is defined as half of I2. In various embodiments of the present invention, intensity I2 represents a logic one (high), and intensity zero represents a logic zero (low).

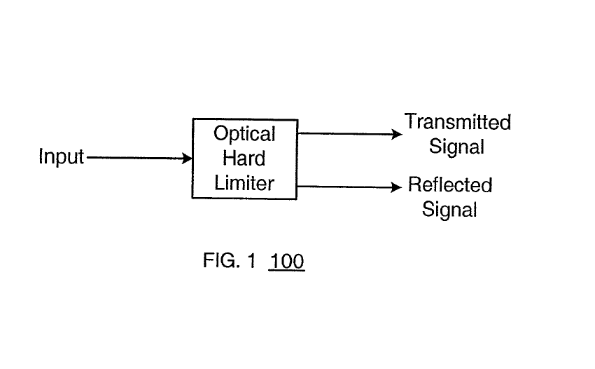

FIG. 1 shows a “black box” view of an exemplary optical hard limiter 100. The optical hard limiter 100 outputs a transmitted signal and a reflected signal based upon the intensity of an input signal.

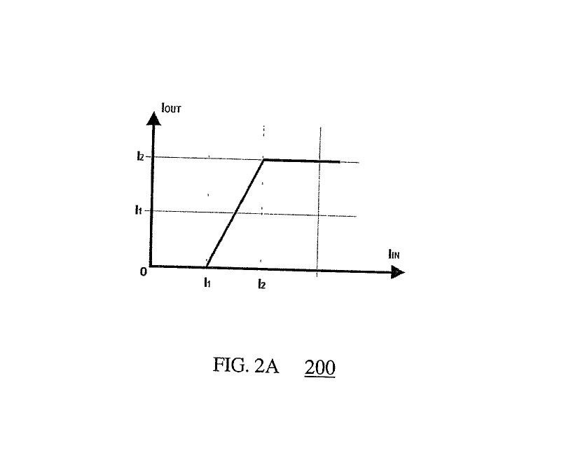

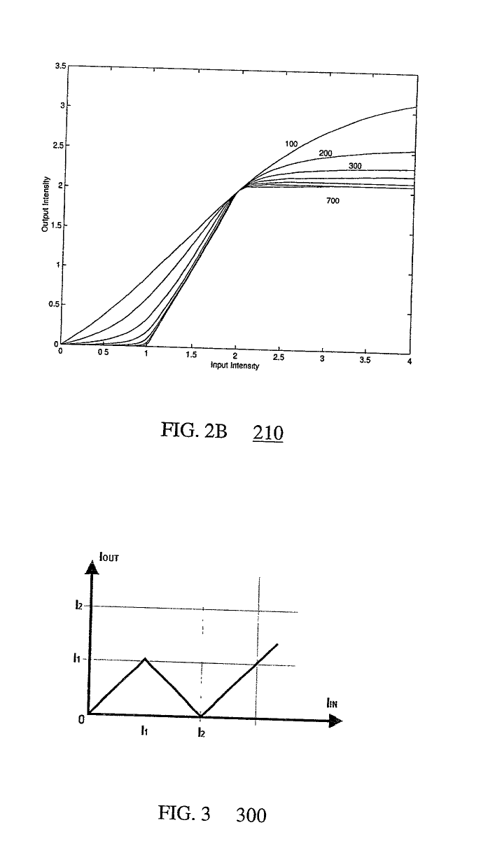

FIG. 2A shows the idealized transmitted transfer characteristics 200 of the optical hard limiter 100. As shown, the transmitted signal is zero for input signals from zero to I1. The transmitted signal increases from zero to 12 as the input signal increases from I1 to I2. The transmitted signal is limited to I2 for input signals above I2.

In actuality, the transmitted transfer characteristics of the optical hard limiter 100 generally differ from the idealized transmitter transfer characterstics 200 shown in FIG. 2A, and depend upon the number of layers in the optical hard limiter 100. FIG. 2B shows simulated transmitted transfer characteristics 210 for finite devices having different numbers of layers. Devices with more layers approach the piecewise linear behavior of the idealized transmitted transfer characteristics 200 shown in FIG. 2A.

FIG. 3 shows the idealized reflected transfer characteristics 300 of the optical hard limiter 100. As shown, the reflected signal increases from zero to I1 as the input signal increases from zero to I1. The reflected signal decreases from I1 to zero as the input signal increases from I1 to I2. The reflected signal increases as the input signal increases above I2.

As with the transmitted transfer characteristics, the actual reflected transfer characteristics of the optical hard limiter 100 generally differ from the idealized reflected transfer characterstics 300 shown in FIG. 3, and depend upon the number of layers in the optical hard limiter 100. Simulated reflected transfer characteristics for finite devices having different numbers of layers are omitted for convenience.

Various all-optical logic devices make use of the transmitted signal and/or the reflected signal of one or more optical hard limiters. Furthermore, various all-optical logic devices can be combined to form additional all-optical logic devices and circuits. A number of exemplary all-optical logic devices based on stable non-absorbing optical hard limiters are described below. It should be noted that other all-optical logic devices can be formed, and the present invention is not limited to the devices shown or to any particular devices. It will be apparent to a skilled artisan how other all-optical logic devices can be formed using the described all-optical logic devices.

It should be noted that, in the described all-optical logic devices, signals are often combined in some proportion using a coupler that is external to the optical hard limiter. The described all-optical logic devices are based on a coupler that reduces the signal intensity by half. It should be noted, however, that the present invention is not limited to the use of such couplers or to couplers that reduce the signal intensity by half.

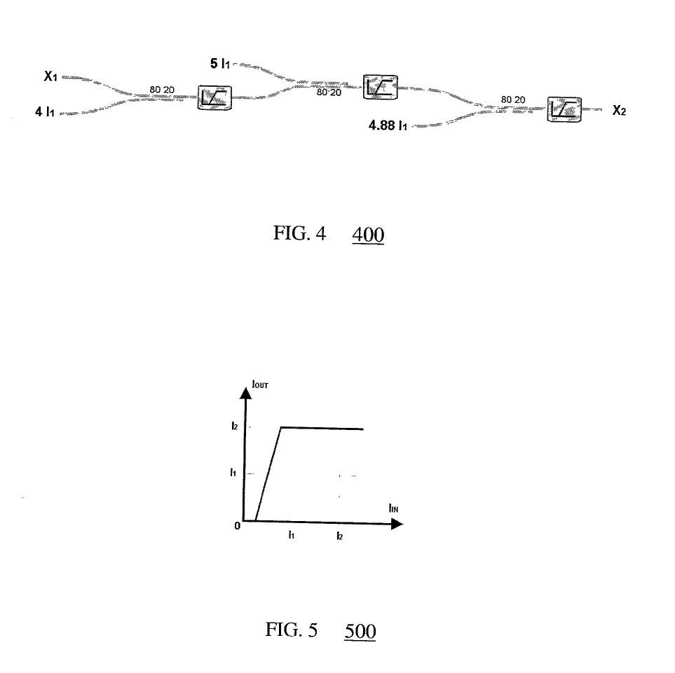

A gain device converts an input signal from {0, I1} to an output signal from {0, I2}. FIG. 4 shows an exemplary all-optical gain device 400 that is created using the transmission characteristics of three optical hard limiters connected in series. The all-optical gain device converts an input signal X1 from {0, I1} to an output signal X2 from {0, I2}. FIG. 5 shows the idealized transfer function 500 of the exemplary gain device 400.

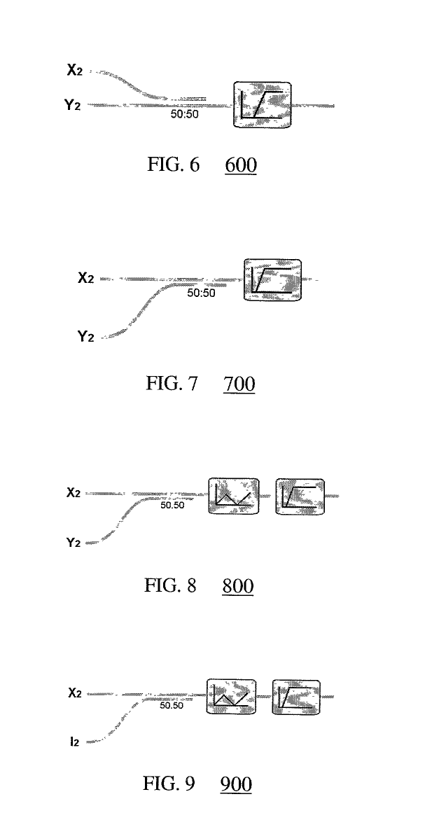

An AND gate outputs a logic one (high) if and only if both inputs are logic one (high) and otherwise outputs a logic zero (low). FIG. 6 shows an exemplary all-optical AND gate 600 that is created using the transmission characteristics of a single optical hard limiter. Inputs X2 and Y2 are combined, and the combined input is fed into an optical hard limiter. The transmitted signal of the optical hard limiter is used as the output of the all-optical AND gate 600. The following table shows the combined input to the limiter and the transmitter signal output of the limiter for the various input signal combinations:

| | | Combined input | Transmitted |
|---|---|---|---|
| Input X2 | Input Y2 | to limiter | signal output |
| 0 | 0 | 0 | 0 |
| 0 | I2 | I1 | 0 |
| I2 | 0 | I1 | 0 |
| I2 | I2 | I2 | I2 |

When the input signal X2 is zero (low) and the input signal Y2 is zero (low), the combined input to the limiter is zero (low). The transmitted signal output of the limiter is zero (low) when the input to the limiter is zero (low). Therefore, the output of the all-optical AND gate is zero (low).

When the input signal X2 is zero (low) and the input signal Y2 is one (high), the combined input to the limiter is I1. The transmitted signal output of the limiter is zero (low) when the input to the limiter is I1. Therefore, the output of the all-optical AND gate is zero (low).

When the input signal X2 is one (high) and the input signal Y2 is zero (low), the combined input to the limiter is I1. The transmitted signal output of the limiter is zero (low) when the input to the limiter is I1. Therefore, the output of the all-optical AND gate is zero (low).

When the input signal X2 is one (high) and the input signal Y2 is one (high), the combined input to the limiter is I2. The transmitted signal output of the limiter is one (high) when the input to the limiter is I2. Therefore, the output of the all-optical AND gate is one (high).

An OR gate outputs a logic one (high) if either or both inputs are logic one (high) and otherwise outputs a logic zero (low). FIG. 7 shows an exemplary all-optical OR gate 700 that is created using the all-optical gain device 400. Inputs X2 and Y2 are combined, and the combined input is fed into a gain element 400. The output of the gain element 400 is used as the output of the all-optical OR gate 700. The following table shows the combined input to the gain element 400 and the gain element output for the various input signal combinations:

| | | Combined input | Gain element |
|---|---|---|---|
| Input X2 | Input Y2 | to gain element | output |
| 0 | 0 | 0 | 0 |
| 0 | I2 | I1 | I2 |
| I2 | 0 | I1 | I2 |
| I2 | I2 | I2 | I2 |

When the input signal X2 is zero (low) and the input signal Y2 is zero (low), the combined input to the gain element is zero (low). The gain element outputs a zero (low) when its input is zero (low). Therefore, the output of the all-optical OR gate is zero (low).

When the input signal X2 is zero (low) and the input signal Y2 is one (high), the combined input to the gain element is I1. The gain element outputs a one (high) when its input is I1. Therefore, the output of the all-optical OR gate is one (high).

When the input signal X2 is one (high) and the input signal Y2 is zero (low), the combined input to the gain element is I1. The gain element outputs a one (high) when its input is I1. Therefore, the output of the all-optical OR gate is one (high).

When the input signal X2 is one (high) and the input signal Y2 is one (high), the combined input to the gain element is I2. The gain element outputs a one (high) when its input is I2. Therefore, the output of the all-optical OR gate is one (high).

An XOR (exclusive-OR) gate outputs a logic one (high) if either one but not both inputs are a logic one (high) and otherwise outputs a logic zero (low). FIG. 8 shows an exemplary all-optical XOR gate 800 that is created using the reflected signal of an optical hard limited in series with an all-optical gain device 400. Inputs X2 and Y2 are combined, and the combined input is fed into an optical hard limiter. The reflected signal of the optical hard limiter is fed into a gain element 400. The output of the gain element 400 is used as the output of the all-optical XOR gate 800. The following table shows the combined input to the limiter, the reflected signal output to the gain element 400, and the gain element output for the various input signal combinations:

| | | | Reflected signal | |
|---|---|---|---|---|
| Input | Input | Combined input | output to | Gain element |
| X2 | Y2 | to limiter | gain element | output |
| 0 | 0 | 0 | 0 | 0 |
| 0 | I2 | I1 | I1 | I2 |
| I2 | 0 | I1 | I1 | I2 |
| I2 | I2 | I2 | 0 | 0 |

When the input signal X2 is zero (low) and the input signal Y2 is zero (low), the combined input to the limiter is zero (low). The reflected signal output of the limiter is zero (low) when the input to the limiter is zero (low). The gain element outputs a zero (low) when its input is zero (low). Therefore, the output of the all-optical XOR gate is zero (low).

When the input signal X2 is zero (low) and the input signal Y2 is one (high), the combined input to the limiter is I1. The reflected signal output of the limiter is I1 when the input to the limiter is I1. The gain element outputs a one (high) when its input is I1. Therefore, the output of the all-optical XOR gate is one (high).

When the input signal X2 is one (high) and the input signal Y2 is zero (low), the combined input to the limiter is I1. The reflected signal output of the limiter is I1 when the input to the limiter is I1. The gain element outputs a one (high) when its input is I1. Therefore, the output of the all-optical XOR gate is zero (low).

When the input signal X2 is one (high) and the input signal Y2 is one (high), the combined input to the limiter is I2. The reflected signal output of the limiter is zero (low) when the input to the limiter is I2. The gain element outputs a zero (low) when its input is zero (low). Therefore, the output of the all-optical AND gate is one (high).

A NOT gate outputs a logic one (high) if a single input is a logic zero (low) and outputs a logic zero (low) if the single input is a logic one (high). FIG. 9 shows an exemplary all-optical NOT gate 900 that is created using the reflected signal of an optical hard limited in series with an all-optical gain device 400. The all-optical NOT gate 900 is a special case of the all-optical XOR gate 800 in which the input Y2 is fixed at a logic one (high). Without further explanation, the following table shows the combined input to the limiter, the reflected signal output to the gain element 400, and the gain element output for the various input signal combinations:

| | | | Reflected signal | |
|---|---|---|---|---|
| | Fixed | Combined input | output to | Gain element |
| Input X2 | input I2 | to limiter | gain element | output |
| 0 | I2 | I1 | I1 | I2 |
| I2 | I2 | I2 | 0 | 0 |

Additional all-optical logic gates and circuits can be formed using the transmitted and reflected signals of the optical hard limiter. Furthermore, the all-optical logic gates described above can be used as building blocks to form additional all-optical logic gates and circuits.

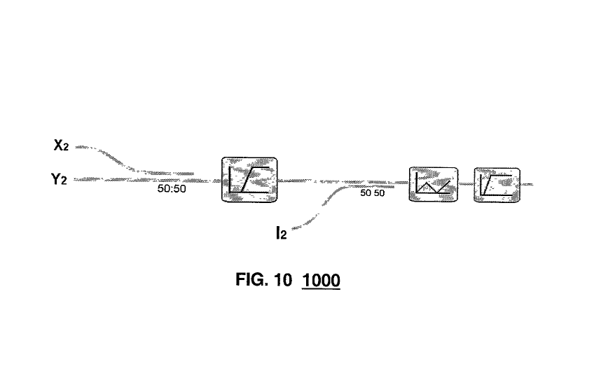

FIG. 10 shows an all-optical NAND gate 1000 formed by coupling the output of an all-optical AND gate 600 as the input to an all-optical NOT gate 900.

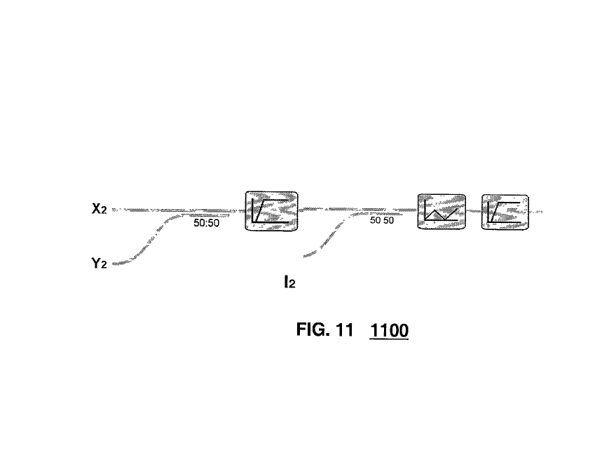

FIG. 11 shows an all-optical NOR gate 1100 formed by coupling the output of an all-optical OR gate 700 as the input to an all-optical NOT gate 900.

Additional considerations are discussed in E. V. Johnson, ALL- OPTICAL SIGNAL PROCESSING AND PACKET FORWARDING USING NONMONOTONIC INTENSITY TRANSFER CHARACTERISTICS, a thesis submitted in conformity with the requirements for the degree of Master of Applied Science, Graduate Department of Electrical and Computer Engineering, University of Toronto (2001), which is hereby incorporated herein by reference in its entirety.

The present invention may be embodied in other specific forms without departing from the true scope of the invention. The described embodiments are to be considered in all respects only as illustrative and not restrictive.

What is claimed is:

1. An optical logic device for processing information optically using the transmitted and/or reflected characteristics of at least one stable, non-absorbing optical hard limiter.

2. The optical logic device of claim 1, wherein the at least one stable, non-absorbing optical hard limiter comprises alternating layers of materials with different linear indices and oppositely signed Kerr coefficients.

3. The optical logic device of claim 1, wherein the transmitted characteristics of a stable, non-absorbing optical hard limiter comprise:
a first range bounded by input signals in the range of approximately zero to I1 in which the transmitted output signal of the stable, non-absorbing optical hard limiter is approximately zero;
a second range bounded by input signals in the range approximately from I1 to I2 in which the transmitted output signal of the stable, non-absorbing optical hard limiter increases from zero to I2; and
a third range bounded by input signals in the range above approximately I2 in which the transmitted output signal of the stable, non-absorbing optical hard limiter is approximately I2, where I1 is approximately half of I2.

4. The optical logic device of claim 1, wherein the reflected characteristics of a stable, non-absorbing optical hard limiter comprise:
a first range bounded by input signals in the range of approximately zero to I1 in which the reflected output signal of the stable, non-absorbing optical hard limiter approximately equal to the input signal;
a second range bounded by input signals in the range approximately from I1 to I2 in which the reflected output signal of the stable, non-absorbing optical hard limiter decreases from approximately I1 for an input signal of I1 to approximately zero for an input signal of I2; and
a third range bounded by input signals in the range above approximately I2 in which the reflected output signal of the stable, non-absorbing optical hard limiter is increases as the input signal increases above I2, where I1 is approximately half of I2.

5. An optical gain element for converting an optical input signal having an intensity substantially from the set {0, I1} to an optical output signal having an intensity substantially from the set {0, I2}, where I1 is approximately half of I2, the all-optical gain element comprising:
a first stable, non-absorbing optical hard limiter operably coupled to receive as its input a combination of the optical input signal and a signal having an intensity of approximately 4 I1 combined in an approximately 80:20 ratio;
a second stable, non-absorbing optical hard limiter operably coupled to receive as its input a combination of the transmitted output signal from the first stable, non-absorbing optical hard limited and a signal having an intensity of approximately 5 I1 combined in an approximately 80:20 ratio; and
a third stable, non-absorbing optical hard limiter operably coupled to receive as its input a combination of the transmitted output signal from the second stable, non-absorbing optical hard limited and a signal having an intensity of approximately 4.88 I1 combined in an approximately 80:20 ratio and to output its transmitted signal as the output of the optical gain element.

6. An optical AND gate comprising a stable, non-absorbing optical hard limiter operably coupled to receive as its input a combination of a first input signal and a second input signal combined in an approximately 50:50 ratio and to output its transmitted signal as the output of the optical AND gate, wherein:
the combined input signal is approximately zero and the output of the optical AND gate is approximately zero when both the first input signal and the second input signal are zero;
the combined input signal is approximately I1 and the output of the optical AND gate is approximately zero when the first input signal is zero and the second input signal is I2;
the combined input signal is approximately I1 and the output of the optical AND gate is approximately zero when the first input signal is I2 and the second input signal is zero;
the combined input signal is approximately I2 and the output of the optical AND gate is approximately I2 when the first input signal is I2 and the second input signal is I2; and
I1 is approximately half of I2.

7. An optical OR gate comprising an optical gain element for converting an optical input signal having an intensity substantially from the set {0, I1} to an optical output signal having an intensity substantially from the set {0, I2, wherein the optical gain element is operably coupled to receive as its input a combination of a first input signal and a second input signal combined in an approximately 50:50 ratio and to output the converted signal as the output of the optical OR gate, and wherein:
the combined input signal is approximately zero and the output of the optical OR gate is approximately zero when both the first input signal and the second input signal are zero;
the combined input signal is approximately I1 and the output of the optical OR gate is approximately I2 when the first input signal is zero and the second input signal is I2;
the combined input signal is approximately I1 and the output of the optical OR gate is approximately I2 when the first input signal is I2 and the second input signal is zero;
the combined input signal is approximately I2 and the output of the optical OR gate is approximately I2 when the first input signal is I2 and the second input signal is I2; and
I1 is approximately half of I2.

8. An optical XOR gate comprising:
a stable, non-absorbing optical hard limiter operably coupled to receive as its input a combination of a first input signal and a second input signal combined in an approximately 50:50 ratio; and
an optical gain element for converting an optical input signal having an intensity substantially from the set {0, I1} to an optical output signal having an intensity substantially from the set {0, I2}, the optical gain element operably coupled to receive as its input a reflected signal from the stable, non-absorbing optical hard limiter and to output the converted signal as the output of the optical XOR gate, wherein:
the combined input signal is approximately zero, the reflected signal is approximately zero, and the output of the optical XOR gate is approximately zero when both the first input signal and the second input signal are zero;
the combined input signal is approximately I1, the reflected signal is approximately I1, and the output of the optical XOR gate is approximately I2 when the first input signal is zero and the second input signal is I2;
the combined input signal is approximately I1, the reflected signal is approximately I1, and the output of the optical XOR gate is approximately I2 when the first input signal is I2 and the second input signal is zero;
the combined input signal is approximately I2, the reflected signal is approximately zero, and the output of the optical XOR gate is approximately zero when the first input signal is I2 and the second input signal is I2; and
I1 is approximately half of I2.

9. An optical NOT gate comprising:
a stable, non-absorbing optical hard limiter operably coupled to receive as its input a combination of an input signal and a fixed signal of approximate intensity I2 combined in an approximately 50:50 ratio; and
an optical gain element for converting an optical input signal having an intensity substantially from the set {0, I1} to an optical output signal having an intensity substantially from the set {0, I2}, the optical gain element operably coupled to receive as its input a reflected signal from the stable, non-absorbing optical hard limiter and to output the converted signal as the output of the optical NOT gate, wherein:
the combined input signal is approximately I1, the reflected signal is approximately I1, and the output of the optical NOT gate is approximately I2 when the input signal is zero;
the combined input signal is approximately I2, the reflected signal is approximately zero, and the output of the optical NOT gate is approximately zero when the input signal is I2; and
I1 is approximately half of I2.

10. An optical NAND gate comprising:
an optical AND gate; and
an optical NOT gate operably coupled to an output of the optical AND gate for logically inverting the output of the optical AND gate, wherein the optical AND gate and the optical NOT gate are based on stable, non-absorbing optical hard limiters.

11. An optical NOR gate comprising:
an optical OR gate; and
an optical NOT gate operably coupled to an output of the optical OR gate for logically inverting the output of the optical OR gate, wherein the optical OR gate and the optical NOT gate are based on stable, non-absorbing optical hard limiters.
